(19) United States
(12) Patent Application Publication
(10) Pub. No.: US 2019/0330938 A1
(43) Pub. Date: Oct. 31, 2019

(54) SYSTEMS AND METHODS FOR DOSING EARTHEN SLURRIES WITH AN ADDITIVE TO MODIFY A FLUID PROPERTY OF THE SLURRY

(71) Applicant: Vermeer Manufacturing Company, Pella, IA (US)

(72) Inventors: Tayte Askelsen, Pella, IA (US); Corey Lanoue, Pella, IA (US); Andy Strobel, Knoxville, IA (US)

(21) Appl. No.: 16/477,053

(22) PCT Filed: Jan. 5, 2018
(86) PCT No.: PCT/US2018/012467

§ 371 Date: Jul. 10, 2019

Related U.S. Application Data
(60) Provisional application No. 62/444,543, filed on Jan. 10, 2017.

(51) Int. Cl. E21B 21/06; E21B 43/34; B03B 1/04

(52) U.S. Cl. CPC E21B 21/066; B03B 1/04; E21B 43/34; E21B 21/068

(57) ABSTRACT

Systems and methods for dosing slurries to remove suspended solids from the slurry are disclosed. The systems and methods may be used to dewater slurries having relatively high solids content such as earthen slurries. In some embodiments, the solids content of the slurry is monitored to determine the amount of dilution water and/or additive added to the slurry.

### CROSS-REFERENCE TO RELATED APPLICATION

This application claims the benefit of U.S. Provisional Patent Application No. 62/444,543, filed Jan. 10, 2017, which is incorporated herein by reference in its entirety.

### FIELD OF THE DISCLOSURE

The field of the disclosure relates to systems and methods for dosing slurries with an additive. In some embodiments, the solids content of the slurry is monitored to determine the amount of additive and/or dilution water added to the slurry.

### BACKGROUND

Various subsurface infrastructure such as power cables, water lines, gas lines, and product piping may be installed by drilling operations. Horizontal directional drilling is a trenchless drilling technique often used in urban areas and for crossing below roads or waterways. Drilling involves formation of a pilot hole along the drill path. The pilot hole is often reamed out to the size of the utility. During drilling, a viscous drilling fluid that typically contains bentonite or polymer is pumped to the cutting head. The drilling fluid, for example, cools the cutting head and carries drill cuttings away from the drill head through the drill bore. Spent drilling fluid may be collected by use of vacuum excavators. Such vacuum excavators may also collect fluid from vertical well drilling.

Vacuum excavators are also used in a process commonly referred to as “potholing”, “daylighting” or “locating.” Potholing involves use of high pressure water that loosens soil to create a hole to visually locate utilities. The mud slurry that is produced is removed by a vacuum and sent to a spoil tank. High pressure systems may also be used to cut trenches with the resulting slurry being sent to a spoil tank of a vacuum excavator. Vacuum excavators may also be used to remove water/mud slurries from valve and meter boxes to provide access to the boxes.

The raw slurry produced during drilling or potholing, typically collected by vacuum excavators, is conventionally landfilled or dumped at a designated disposal site. Landfill disposal of slurries containing a large amount of water may be relatively expensive compared to disposal of solids alone. Further, tightening regulations may limit disposal options for such slurries. The relatively high solids content of slurries prohibits their disposal in water treatment facilities, even after the slurry is pretreated to remove larger solids from the slurry.

A need exists for dewatering systems and methods for processing earthen slurries such as drill cuttings and cuttings from potholing. A need exists for systems and methods that allow batches of slurry having a more consistent solids content between batches to be produced for dewatering of the slurry.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a system for adding an additive to an earthen slurry to remove suspended solids. The system includes a batch mix tank and a sensor to determine the amount of solids added to the batch mix tank. The system includes a dilution water feed system for adding water to the batch feed tank to dilute the slurry and includes a dilution control system. The dilution control system includes a dilution control system controller for controlling the amount of water added to the batch mix tank. The system also includes an additive feed system for adding an additive to the batch mix tank to modify a fluid property of the slurry in the batch mix tank.

Yet another aspect of the present disclosure is directed to a method for adding an additive to an earthen slurry to remove suspended solids. Earthen slurry is added to a batch mix tank. The amount of solids added to the batch mix tank is determined. Water is added to the batch mix tank to dilute the slurry. The amount of water added is based at least in part on the amount of solids and/or earthen slurry added to the batch mix tank. An additive is added to the batch mix tank to modify a fluid property of the slurry in the batch mix tank.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a schematic of a system for dosing a slurry to remove suspended solids;

FIG. 2 is a schematic of a pretreatment system, the dosing system and a separation system for dewatering earthen slurries;

FIG. 3 is a schematic of a pretreatment system, the dosing system and a separation system for dewatering earthen slurries in which water is decanted from the dosing system; and

FIG. 4 is a schematic of a pretreatment system, a coagulant dosing system, a separate flocculant tank, and a separation system for dewatering earthen slurries.

Corresponding reference characters indicate corresponding parts throughout the drawings.

### DETAILED DESCRIPTION

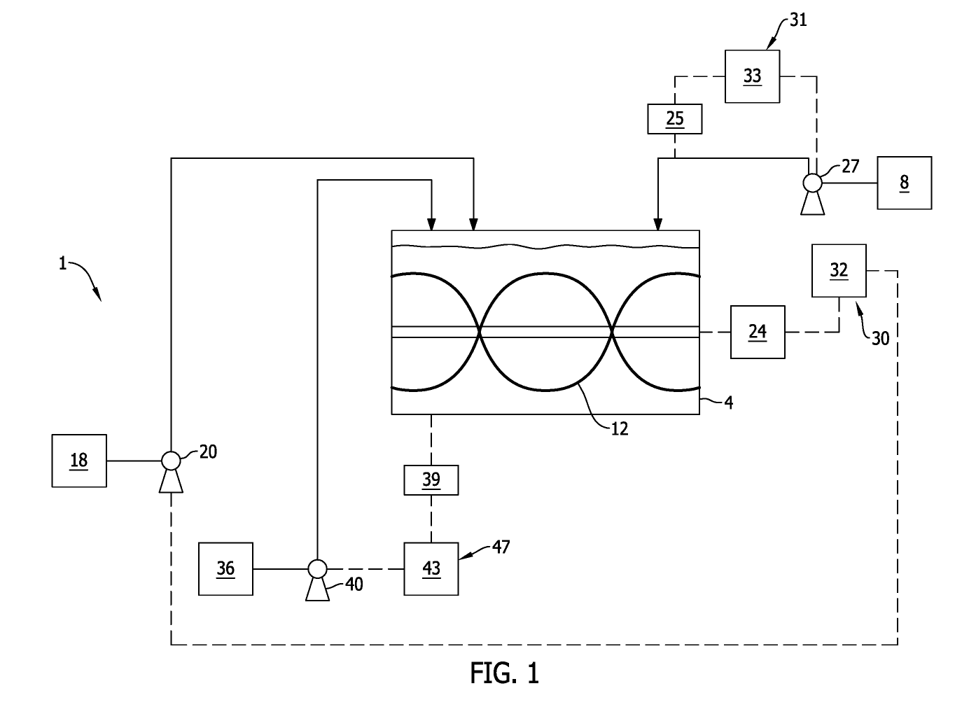

A system 1 for dosing slurries such as pretreated earthen slurries is shown in FIG. 1. The system includes a batch mix tank 4 (or simply “mix tank”). Slurry to be processed is introduced into the mix tank 4 from slurry source 8. The batch mix tank 4 may include a mixing system 12 therein for mixing the slurry and additives.

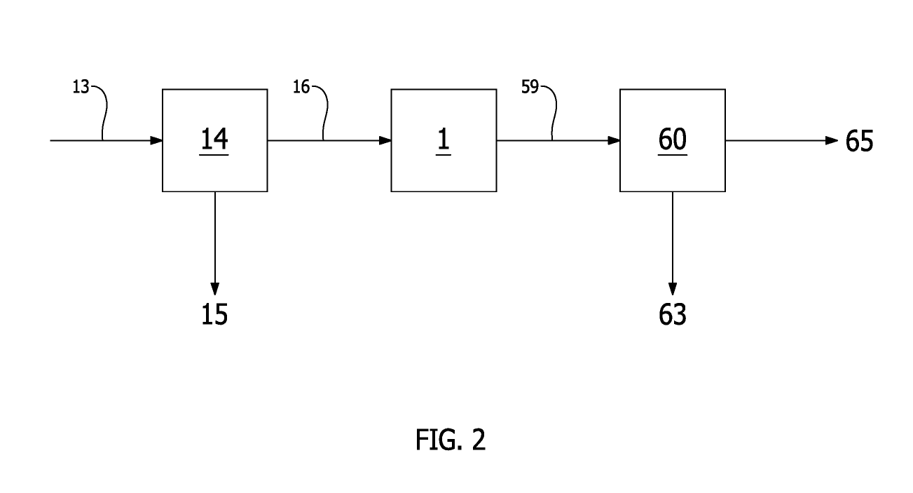

In some embodiments, the slurry that is processed is an earthen slurry 13 (FIG. 2) that has been processed in a pretreatment system 14. Earthen slurries 13 that may be pretreated include slurries of earth and water such as cuttings from a drill site (vertical drill or horizontal drill site) or from potholing, hydro-excavation trenching and/or from other excavation or mining sites in which earthen solids suspended in water are involved. Such slurries may be transported and offloaded for pretreatment 14 from vehicles known in the art as vacuum excavators and, particularly, hydro excavators.

The earthen slurry that is pretreated may include water and earth that was loosed during drilling/potholing or a mining operation. The slurry may also include various additives that are added to the water for drilling purposes (e.g., to modify the viscosity of the fluid) such as bentonite and/or polymers. The slurry may include at least about 10 wt % solids, at least about 30 wt % solids or even at least about 50 wt % solids (e.g., from about 10 wt % to about 80 wt % solids or from about 30 wt % to about 80 wt % solids).

The earthen slurry is introduced into a pretreatment system 14 to remove a first portion of solid particles 15 such as larger particles or clumps that are capable of settling in the slurry. The pretreatment system 14 may include various mechanical separation units that separate solids from the slurry by size or weight. Exemplary processing units that may be used include, for example, screens, shakers, centrifuges and the like. After pretreatment, the pretreated slurry 16 is depleted of solids relevant to the earthen slurry 13. The pretreated slurry 16 contains an amount of solids (e.g., suspended solids) such as at least about 10 wt % solids, at least about 30 wt % solids or even at least about 50 wt % solids (e.g., from about 10 wt % to about 80 wt % solids or from about 30 wt % to about 80 wt % solids). An exemplary pretreatment system that may be used is disclosed in U.S. Provisional Patent Application No. 62/393,151, filed Sep. 12, 2016 and entitled “Systems and Methods for Processing Earthen Slurries”, published as U.S. Patent Publication No. ______, which is incorporated herein by reference for all relevant and consistent purposes.

The slurry source 8 (FIG. 1) used in the dosing system 1 may be pretreated slurry 16 that is collected in the pretreatment system 14 (e.g., a collection tank of the pretreatment system 14) or may be slurry that is stored downstream of pretreatment 14 such as slurry stored in a slurry source tank or container. The treatment system 1 of the present disclosure may be at or near the same site of the pretreatment system 14 such that the pretreated slurry is pumped or gravity fed to the system 1. Alternatively, slurry may be transported by one or more transport vehicles to the site of the system 1. The slurry may be introduced into the mix tank 4 directly from such transport vehicles, or such vehicles may offload slurry into a slurry storage tank.

In some embodiments, the batch mix tank 4 is sized to hold at least about 50 gallons of slurry or at least about 250 gallons, at least about 500 gallons, at least about 750 gallons or at least about 1000 gallons (e.g., from about 50 gallons to about 5,000 gallons, from about 500 gallons to about 1,000 gallons or from about 1,000 gallons to about 2,000 gallons).

Slurry from the slurry source 8 is introduced in the mix tank 4 by a slurry feed system 27 (shown as a slurry pump). In this regard, in various embodiments processing generally proceeds (e.g., additives are added to modify the physical properties of the slurry) according to a batch process in which slurry is not introduced or removed from the tank 4. Such batch processing may include recirculation loops which may be used to assist in mixing of the tank 4.

In some embodiments, the amount of slurry added to the mix tank 4 is controlled to achieve a desired amount of solids and/or solids concentration in the mix tank and/or to achieve a desired fill height by addition of dilution water. The system 1 includes a sensor 25 to determine the amount of solids added to the batch mix tank. The sensor 4 senses a parameter related to the total solids in the tank 4 (e.g., solids concentration, flow rate or the like). The sensor 25 is communicatively coupled to a slurry control system 31 having a slurry control system controller 33. The controller 33 is also communicatory coupled to the slurry feed system 27 to control the amount of solids added to the batch mix tank 4.

The controller 33 is configured to determine the amount of solids added to the batch mix tank 4 and to send a signal to the feed system 27 to stop addition of slurry when the total amount of solids added to the batch mix tank 4 is equivalent to a pre-determined, target set-point. The target set-point for the amount of solids added to the tank 4 may be pre-determined to allow a consistent amount of additive to be added to the tank to modify a fluid property of the slurry (i.e., to allow the tank to contain generally the same amount of solids from batch to batch and/or the same solids concentration after dilution water is added).

In the illustrated embodiment, the sensor 25 analyzes the incoming slurry (i.e., the slurry in the slurry feed stream) to provide information related to the solids content while the slurry is fed to the batch mix tank. In other embodiment, the sensor 25 may be in fluid communication with the tank 4 to detect the solids content of the slurry in the tank during or after slurry addition.

The sensor 25 may be configured in a suitable manner that provides information related to the total solids content of the batch mix tank 4. The sensor 25 is generally configured with the controller 33 to determine the total amount of solids added to the tank 4. For example, the sensor 25 may detect the specific gravity (i.e., density) of the slurry, solids content of the slurry (i.e., solids concentration) and/or the flow rate of the feed slurry (e.g., volumetric or mass) fed into the tank 4. The sensor 25 may detect the total mass or volume of slurry added to in the tank 4. In some embodiments, the sensor 25 is used with other sensors (e.g., a sensing system having one sensor that determines mix tank slurry level or volume and a second sensor that detects total mass).

In some embodiments, once the target set-point of the amount of solids added to the mix tank 4 is achieved and addition of slurry is stopped, water is added to the batch mix tank 4 to dilute the slurry. The amount of water added may be based on the amount of solids added to the batch mix tank and/or the total amount of slurry added to the batch mix tank. For example, the amount of water that is added may be determined from a desired solids concentration of the tank (i.e., to lower the solids concentration to or below a threshold) and/or to achieve a desired fill level in the tank 4. Generally, earthen slurries with a higher solids content will use more dilution water to achieve the desired solids concentration (e.g., for a given target fill level) and more dilute earthen slurries will use less dilution water.

In some embodiments, the expected volume of additive added to the tank (i.e., either an assumed consistent volume of a calculated volume) may also be used to determine the amount of dilution water to add to the tank, so as to achieve a desired fill height after the dilution water and the additive are added. In other embodiments, the volume of additive is negligible.

In this regard, the sensor 25 (or sensors if more than one are used) may be configured with the controller 33 to achieve (1) a consistent solids content in the tank (i.e., both the total mass of solids in the tank and concentration of solids after dilution) and (2) a consistent fill level.

The system 1 may include a dilution water feed system 40 (show as a dilution water feed pump) for adding water to the batch tank 4 to dilute the slurry 8). The system 1 may also include a dilution control system 47 having a dilution system controller 43 for controlling the amount of water added to the batch mix tank 4. The controller 43 may be communicatively connected to sensors such as the sensor 25 used to determine the total mass of solids content or a tank level sensor 39 to add water for proper dilution of the earthen slurry and/or to achieve a desired fill level. In some embodiments, the dilution system controller 43 is the same controller as the slurry control system controller 33. In other embodiments the dilution system controller 43 and slurry control system controller 33 are separate controllers.

Water used for dilution may be stored in a water feed tank 36 and may be gravity fed or introduced into the mix tank 4 by a water feed pump. Water may be mixed with the slurry in the mix tank 4 by use of a mixing system 12.

Water may be added directly to the mix tank 4 as shown in FIG. 1 or may be added upstream (e.g., in a pretreatment collection vessel or added to the slurry feed or with the coagulant feed). In various embodiments, water may be added to dilute the slurry in the batch mix tank 4 such that the slurry has less than about 60 wt % solids, less than about 50 wt % solids or less than about 40 wt % solids (e.g., about 20 wt % to about 60 wt % or to about 20 wt % to about 40 wt % solids).

An additive is added to the batch mix tank 4 to modify a fluid property of the slurry (i.e., diluted slurry) in the batch mix tank 4 during or after slurry 8 or dilution water 36 is introduced into the mix tank 4. The additive may aid in the removal of suspended solids from the slurry (e.g., may be a flocculant and/or coagulant). An additive feed system 20 (e.g., having additive feed pump as shown) may be used to transfer additive from an additive source 18 to the batch mix tank 4. The source of additive 18 may be any suitable container for holding additive including a dedicated tank, transportable totes or tanks, barrels or bins. The additive feed system 20 may include any suitable device for adding material including centrifugal pumps, displacement pumps (e.g., syringe-style pump), diaphragm pumps, peristaltic pumps and progressive cavity pumps.

An additive control system 30 having an additive control system controller 32 communicatively coupled to the additive feed system 20 controls additive addition based on a change in the fluid property of the slurry (i.e., diluted slurry). In some embodiments, a second sensor 24 (with the sensor 25 described above being the “first” sensor) is used to sense the fluid property of the slurry.

In this regard, the fluid property of the slurry that is monitored may be any property that is adjusted as part of a method to remove suspended solids from the slurry. For example, the fluid property may be selected from the zeta potential of the slurry, turbidity of the slurry, streaming current of the slurry, the presence and/or location of a solid-liquid interface during settling of solids in the slurry, pH or viscosity. The second sensor 24 may be a zeta potential sensor (e.g., as in embodiments in which coagulant is added), a turbidity sensor, a camera (e.g., to view the interface between the settled solids and the supernatant water), a laser or guided radar level sensor to measure depth of the solids-liquid interface, a differential pressure sensor (e.g., configured to measure the difference in specific gravity between the top supernatant and the settled flocs) or a penetrometer (e.g., configured to measure the depth and resistance of the settled flocs). In embodiments in which the sensor is a zeta potential sensor, the zeta potential sensor may be an electroacoustic sensor having a generator for generating either an oscillating acoustic pressure wave (as in colloidal vibration current applications) or an oscillating electric field voltage (as in electric sonic amplitude applications) and a detector for measuring current or potential (i.e., voltage).

The second sensor 24 may be configured to provide relatively quick feedback to control additive addition. For example, the second sensor 24 may be configured to measure the fluid property of the slurry every 2 minutes or at least every 1 minute, at least every 30 seconds, at least every 20 seconds, at least every 10 seconds or even at least every 5 seconds. The second sensor 24 may be configured to provide measurement in the desired period of time by, for example, lowering the threshold at which the second sensor 24 records a data point.

The additive may aid in the removal of suspended solids from the slurry. Typically the additive is a liquid; however, in other embodiments, the additive may be a solid. The additive may be a ready-to-use formulation or may be formulated in the additive tank 18.

In some embodiments, the additive is a coagulant. In such embodiments, a flocculant is also added to the batch mix tank 4 after the coagulant has been added (e.g., after the coagulant has lowered the absolute value of the zeta potential to an amount in which flocculant adequately causes solids to aggregate). When coagulant and flocculant are added, at least one of coagulant and flocculant are controlled by the additive feed system 20 and control system 30. In this regard, in some embodiments the system includes a second additive feed system and a second additive control system that are analogous to the systems 20, 30 to allow both coagulant and flocculant to be controlled as described above.

In other embodiments, the additive added by additive feed system 20 and control system 30 is a flocculant. In such embodiments, flocculant may be added with or without coagulant being added before flocculant addition.

During addition of additive to the mix tank 4, a mixing system 12 mixes the contents of batch mix tank 4. In the illustrated embodiment, the mixing system 12 is a mixing auger. In other embodiments, the mixing system 12 may be a rolljet, propeller or other style mixer. Preferably, the mixing system 12 is capable of providing a variable shear input to the fluid (e.g., variable mixing speed) depending on the stage of mixing (e.g., dilution, coagulation or flocculation).

In some embodiments (such as when flocculant is added alone), the additive may be added in steps. An initial or first dose of flocculant may be added. The amount of the first dose may be the same from batch to batch (e.g., as when addition of dilution water is controlled to provide a target total solids content in the mix tank 4). In other embodiments, the amount of the first dose is adjusted bases on a measured and/or calculated solids content of the batch mix tank 4.

After the first dose is added, the fluid property of the slurry is sensed and the second dose of additive is added to the batch mix tank 4. The amount of the second dose is based on the sensed fluid property. The fluid property may be sensed after a predetermined mix time to allow the first dose to properly mix and adjust the fluid property of the slurry. After the fluid property is sensed and after the predetermined mix time, a second dose of additive is added with the amount of the second dose being based at least in part on the sensed fluid property. After addition of the second dose, the fluid property of the slurry may be sensed after mixing. Addition of additive may continue in dosing increments until the fluid property is within a suitable range.

When flocculant is added, after the predetermined mix time (e.g., 5 to 30 seconds), the mixing system 12 may be stopped or slowed to allow floc to settle. The sensor 24 measures the fluid property to determine if flocculation was sufficient to settle out solids. The mixing system may be operated or sped-up and a second dose of slurry may be added based on the fluid property. Flocculant may be added in successive cycles until the desired flocculation is achieved. In this regard, the additive control system controller 32 may be configured to add flocculant in two or more doses as follows:
(a) addition of first dose with the amount of first dose based on at least one of:
   (i) assumed/target mass of solids in batch mix tank;
   (ii) measured/calculated mass of solids in batch mix tank;
   (iii) measured specific gravity of feed slurry added to batch mix tank;
   (iv) pH;
   (v) dose history of previous batches; or
   (vi) other factors (color, turbidity, soil type, region, source of slurry or the like)
(b) mixing period to incorporate first dose;
(c) reduction or stoppage of mixing system to allow for floc settling;
(d) sensing of fluid property;
(e) addition of second dose with the amount being based on the sensed fluid property;
(f) mixing period to incorporate second dose;
(g) reduction or stoppage of mixing system to allow for floc settling;
(h) sensing of fluid property; and
(i) potential additional dosing cycles to achieve sufficient flocculation.

In embodiments in which the additive is coagulant, the coagulant may be any suitable material that acts to destabilize the slurry suspension. Exemplary coagulants include hydrolyzing metal salts (e.g., aluminum sulfate, ferric chloride or sulfate), pre-hydrolyzed metal salts (e.g., polyaluminum chloride or sulfate or polyiron chloride) or synthetic polymers including cationic polymers (e.g., epi-DMA, aminomethyl polyacrylamide, polyalkylene, polyamines or polyethylenimine).

In embodiments in which the additive is flocculant (which optionally may be added with or without coagulant), the flocculant may be any suitable material that causes suspended particles to aggregate and form flocs. Suitable flocculants that may be added to the batch mix tank to agglomerate the coagulated slurry include synthetic cationic polymers (e.g., polydiallyldimethl chloride, polydimethyl aminomethyl polyacrylamide, polyvinylbenzyl or trimethyl ammonium chloride), synthetic neutral polymers (polyacrylamides), synthetic anionic polymers (hydrolyzed polyacrylamides, polyacrylic acid, polystyrene sulfonate or polyacrylates), natural polymers (e.g., sodium alginate, chitosan or starch) and inorganic flocculants (e.g., aluminum chloride, aluminum chlorohydrate, aluminum chlorohydroxide, bentonite or kaolite clays). In some embodiments, the system includes two flocculant pumps and/or flocculant feed tanks to allow two different flocculants to be added to the mix tank 4.

After flocculation, the mixer may be stopped or reduced in speed and flocs are allowed to settle. The flocculated slurry is then discharged from the batch mix tank 4. The flocculated slurry may be gravity drained, pumped or tipped from the tank 4. The flocculated slurry 59 (FIG. 2) may then be introduced into a separation system 60 to produce a solid fraction 63 and liquid fraction 65. The separation system 60 may separate the solid fraction 65 from the flocculated slurry 59 by centrifugation (e.g., decanter centrifuge, basket centrifuge, screen centrifuge or hydrocyclones), filtration sedimentation (e.g., belt press, filter press, filter bags or vacuum filtration) or by thermal drying.

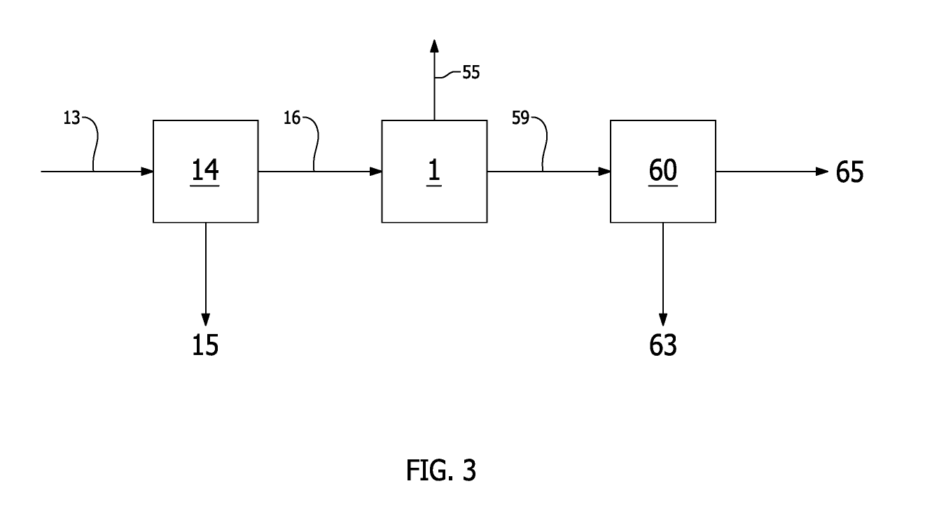

In some embodiments and as shown in FIG. 3, water above the interface of the settled solids (i.e., supernatant water) is removed before the solids are discharged. This supernatant water 55 may be separated by gravity draining the water through a discharge above the solid-liquid interface or by tipping the tank 4 and taking a first cut of liquid as supernatant water. In embodiments in which solids are gravity drained or the batch mix tank 4 is tipped to discharge the solids, removing supernatant water may reduce the amount of turbulence and “sloshing” of solids which may break apart the flocs in the settled solids. Removal of the supernatant water 55 from the system reduces the throughput capacities required of the separation system 60 (e.g., at least about 20%, at least about 40% or at least about 60% of the water in the batch mix tank may be removed as supernatant water). Additionally, removal of the supernatant water 55 may allow for the feed to the separation system 60 to be more consistent as the settled solids may have a similar solids content from batch to batch. This allows the separation system 60 to be tuned for the more consistent feed which improves throughput. The separated supernatant water 55 may have a lower turbidity than the liquid fraction 65 recovered from the separation system 60 allowing it to be disposed of separately from the liquid fraction (e.g., recycled such as by backwashing filters or the like). In other embodiments, the separated supernatant water 55 is disposed with the liquid fraction 65. The batch tank 4 may be configured to allow the supernatant water to be decanted (e.g., include vertically adjustable discharge or weir).

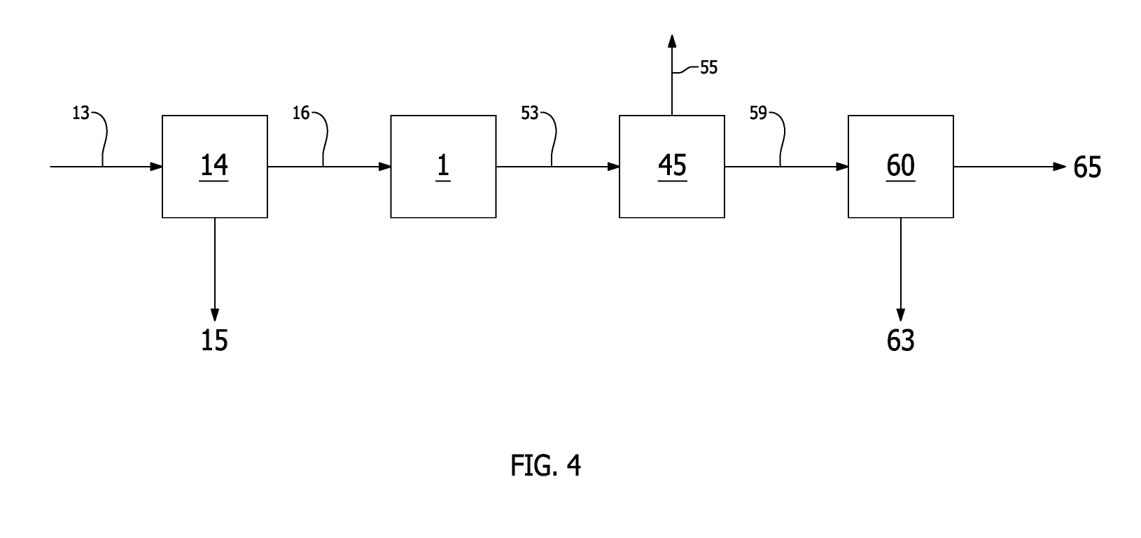

In some embodiments in which coagulant and flocculant are used to process the slurry, after addition of coagulant, the coagulated slurry is discharged into a separate flocculant tank 45 (FIG. 4). Flocculant is added to the coagulated slurry in tank 45 and, after settling, supernatant water 55 is separated from the solids. Solids are discharged from the flocculant tank 45 and processed in separation system 60.

In this regard, it should be noted that some flocculated solids may float. The amount of solids which may float are expected to be small (e.g., less than 5%, less than 1% or less than 0.5% of the total flocculated solids) relative to the amount of solids which settle in the batch mix tank 4. Any floating solids may be removed from supernatant water and, optionally, filtered from the supernatant water (e.g., bag or cartridge-style filters).

The solid fraction 63 from the separation system 60 may be disposed by re-use in construction or may be landfilled. The liquid fraction 65 and/or supernatant water 55 may be disposed by re-use in drilling operations or used in other applications such as in dust control. The liquid fraction 65 is depleted in solids relative to the pretreated slurry 16. In some embodiments, at least about 90 wt %, at least about 95 wt % or even at least about 98 wt % (e.g., from about 90 wt % to about 100 wt % of from about 95 wt % to about 100 wt %) of the solids in the pretreated slurry 16 is removed by the treatment system 1 and separation system 60.

In some embodiments, the liquid fraction 65 is monitored by one or more sensors (not shown) and the output from the sensors is used, in part, to modify the amount of water added for dilution or coagulant or flocculant addition.

Various embodiments of the system 1 may be configured to be a mobile system that allows the system to be transported to various sites such as a central location between drilling sites. The system may have a common frame or skid that supports the batch mix tank and the various pumps (e.g., coagulant pump, flocculant pump and/or water pump) and/or tanks (e.g., water tank, coagulant tank and/or flocculant tank). The system may include skids, rollers or legs which may be vertically extended (not shown) to allow the system to be pulled or lifted onto a transport vehicle (e.g., trailer). In other embodiments, the system includes ground-engaging wheels (or even tracks) for moving the system (e.g., is mounted to a trailer for transport). In other embodiments, the system is fixed at a site (i.e., is not mobile or arranged for disassembly and transport) and slurry (e.g., earthen slurry) is transported to the system without transport of the system during its lifespan.

Generally, the mix tank 4 is a batch mix tank in which batches of slurry are processed in succession such as when a sufficient amount of slurry has been collected to process a full batch of slurry. After the slurry is processed and discharged, a second slurry may be added to the batch mix tank 4 and processed as described herein to remove solids (e.g., dilution, coagulation and flocculation).

In some embodiments including embodiments in which only flocculant is used as an additive (i.e., no coagulant is added) or both coagulant and flocculant are added, the total time to process a batch and achieve successful flocculation may be less than 20 minutes, less than 15 minutes, less than 10 minutes or even less than 5 minutes.

In embodiments in which earthen slurries are processed, after a first slurry from a first transport vehicle is processed in a pretreatment system 14 (FIG. 2), slurry from a second vehicle is processed in the pretreatment system 14. Depending on the relative sizes of the first and second slurries, the size of the collection vessel in the pretreatment system 14, and the size of the batch mix tank 4, the first and second slurries may be processed separately in succession in the batch mix tank or may be processed together (e.g., combined prior to introduction into the batch mix tank or combined in the batch mix tank).

Compared to conventional systems and methods for dewatering slurries, the systems and methods of the present disclosure have several advantages. By monitoring the solids content of the earthen slurry that is introduced into the batch mix tank, the amount of dilution water added may be adjusted to produce a slurry with a consistent solids concentration (i.e., specific gravity). This allows a consistent amount of additive (e.g., flocculant to be added to the slurry from batch to batch) and allows downstream processing (e.g., separation of solids from the slurry) to be better tuned to improve separation. By monitoring the earthen slurry to determine the solid content, the dilution water and additive volumes may also be determined and the amount of slurry added to the mix tank may be controlled to achieve a desired tank fill height. Maintaining a desired fill height allows additive to be better distributed throughout the slurry.

In embodiments in which batch processing of slurry is used such as in systems in which slurry is processed upon collection of a full batch of slurry (e.g., as in dewatering of earthen slurries), the system may better recover from dosing errors as the feedback may be more representative of the slurry being dosed. Use of relatively large batches allows smaller batches (e.g., vacuum truck slurries in embodiments in which earthen slurries are processed) to be combined which averages out variability in the smaller batches and results in a more consistent feed for various process stages. Batch processing while mixing may create more consistent shear rates relative to an in-line system as the slurry viscosity may vary more in such in-line systems.

Dilution of the slurry prior to or during addition of additive allows for better mixing and contact of coagulant and slurry during dosing which reduces coagulation usage (e.g., mixing to less than about 40 wt % solids). Dilution allows high solids content slurries to be better processed.

In embodiments in which flocculant only (i.e., not coagulant) is added to the mix tank, the system may be simplified as coagulant pumps, control systems and the like may be eliminated. Further, the response may be easier to predict as one additive variable (flocculant addition) is controlled rather than multiple variables (e.g., coagulant and flocculant addition).

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1. A system for adding an additive to an earthen slurry to remove suspended solids, the system comprising:
a batch mix tank;
a sensor to determine the amount of solids added to the batch mix tank;
a dilution water feed system for adding water to the batch feed tank to dilute the slurry;
a dilution control system comprising a dilution control system controller for controlling the amount of water added to the batch mix tank; and
an additive feed system for adding an additive to the batch mix tank to modify a fluid property of the slurry in the batch mix tank.

2. The system as set forth in claim 1 wherein the sensor is configured to measure at least one of the specific gravity of the slurry, solids content of the slurry, volume of slurry added to the batch mix tank, mass of slurry added to the batch mix tank, volumetric flow rate of the slurry added to the batch mix tank or mass flow rate of slurry added to the batch mix tank.

3. The system as set forth in claim 1 comprising a slurry control system for controlling the amount of slurry added to the batch mix tank.

4. The system as set forth in claim 3 wherein the slurry control system comprises a slurry control system controller communicatively coupled to a slurry feed system to control the amount of solids added to the batch mix tank.

5. (canceled)

6. The system as set forth in claim 4 wherein the sensor is communicatively coupled to the slurry control system controller, the slurry control system controller configured to determine the amount of solids added to the batch mix tank.

7. The system as set forth in claim 1 wherein the sensor is a first sensor, the system further comprising a second sensor for sensing the fluid property of the slurry.

8. The system as set forth in claim 7 further comprising an additive control system, the additive control system comprising an additive control system controller communicatively coupled to the additive feed system and configured to control additive addition based on the fluid property.

9. The system as set forth in claim 8 further comprising a mixing system in the batch mix tank, wherein the additive control system controller is configured to add a first dose and a second dose of additive, the second dose being added after a target mix time.

10. The system as set forth in claim 7 wherein the second sensor is configured to measure the fluid property of the slurry every 2 minutes.

11. The system as set forth in claim 7 wherein the second sensor is configured to measure at least one of the zeta potential of the slurry, turbidity of the slurry, streaming current of the slurry, the presence and/or location of a solid-liquid interface during settling of solids in the slurry, pH and viscosity.

12. The system as set forth in claim 1 wherein the additive feed system comprises an additive feed pump.

13. (canceled)

14. The system as set forth in claim 1 wherein the system is a mobile system to allow the system to be transported to different sites.

15-16. (canceled)

17. The system as set forth in claim 1 comprising a mixing system within the batch mix tank for mixing the contents of the batch mix tank.

18. (canceled)

19. A method for adding an additive to an earthen slurry to remove suspended solids, the method comprising:
adding earthen slurry to a batch mix tank;
determining the amount of solids added to the batch mix tank;
adding water to the batch mix tank to dilute the slurry, the amount of water being added being based at least in part on the amount of solids and/or earthen slurry added to the batch mix tank; and
adding an additive to the batch mix tank to modify a fluid property of the slurry in the batch mix tank.

20. The method as set forth in claim 19 wherein addition of earthen slurry to the batch mix tank is terminated when the total amount of solids added to the batch mix tank is equivalent to a target set-point.

21. The method as set forth in claim 20 comprising adding water to the batch mix tank after the solids target set-point is achieved, water being added to the batch mix tank until the slurry level is equivalent to a target level set-point.

22. The method as set forth in claim 19, the method comprising:
adding a first dose of additive to the batch mixed tank;
sensing the fluid property of the slurry in the batch mix tank after the first dose of additive is added and after a predetermined mix time; and
adding a second dose of additive to the batch mix tank, the amount of second dose being based at least in part on the sensed fluid property.

23. The method as set forth in claim 19 wherein the additive is selected from coagulant and flocculant.

24. The method as set forth in claim 19 wherein the fluid property is selected from the zeta potential of the slurry, turbidity of the slurry, the presence and/or location of a solid-liquid interface during settling of solids in the slurry, pH and viscosity.

25. The method as set forth in claim 19 wherein determining the amount of solids added to the batch mix tank comprises sensing the concentration of solids in a slurry feed steam.

26. (canceled)
